(19) United States
(12) Patent Application Publication
(10) Pub. No.: US 2005/0005984 A1
(43) Pub. Date: Jan. 13, 2005

(54) Mechanically removable hygienic end cap

(76) Inventors: Robert J. Elbich, Fogelsville, PA (US); Craig E. Traugher, Bath, PA (US)

Correspondence Address: Karen P. Crowley;Buchanan Ingersoll PC, 14th Floor, 1835 Market Street, Philadelphia, PA, 19103, US

(21) Appl. No.: 10/886,912

(22) Filed: Jul. 8, 2004

Related U.S. Application Data
(60) Provisional application No. 60/485,938, filed on Jul. 9, 2003.

(51) Int. Cl. F16L 55/10

(52) U.S. Cl. 138/89; 138/96 R

(57) ABSTRACT

An improved hygienic end cap that can be rapidly removed using a hygienic clamp as a tool. The hygienic end cap contains a feature on its end that can accept the tang of a hygienic clamp to pry off the end cap from the hygienic union. The use of a hygienic clamp enables the user to rapidly disassemble the hygienic union without the need to locate specialized tools since the clamp can be procured from the hygienic union during disassembly. The mechanical advantage of using a hygienic clamp as the fulcrum also results in more controlled removal of the cap and less potential injury to personnel.

### RELATED APPLICATIONS

This application claims priority to provisional application Ser. No. 60/485,938 filed on Jul. 9, 2003, the contents of which are incorporated herein by reference in their entirety.

### FIELD OF THE INVENTION

The present invention relates to hygienic end caps and to a method for removing end caps from hygienic unions found on the ends of pipes and tops of containers used in industries employing hygienic processes. More particularly, it relates to a hygienic end cap with a protrusion that can be pried using a hygienic clamp as a fulcrum to remove the end cap from the hygienic union.

### BACKGROUND OF THE INVENTION

The use of hygienic unions is common in the pharmaceutical, biopharmaceutical, and food processing industries because of its ease of assembly/disassembly and its ability to provide a hygienic seal that can be separated. The disassembly of hygienic unions is performed frequently to clean or maintain the hygienic union, equipment, or vessels. The most common terminal hygienic union, shown in FIG. 1, consists of a ferrule 10, gasket 14, end cap 16 and clamp. The gasket is used to seal the flat surfaces of the ferrule 12 and end cap and is compressed by the surrounding clamp 20, shown in FIG. 2, to insure a hygienic seal. Numerous improvements have been made to the basic hygienic union with respect to clamps, gaskets, ferrules, and end caps.

U.S. Pat. No. 1,162,362 and 2,673,102 describe the basic hygienic union. Multi-segment clamps including three piece clamps are described in U.S. Pat. No. 4,568,115, U.S. Pat. No. 3,181,901 and U.S. Pat. No. 4,123,095. Four piece clamps are shown in U.S. Pat. No. 2,788,993. All of these clamps have a common tang that can be used as a fulcrum to pry the inventive cap for rapid removal from the hygienic union.

U.S. Pat. No. 6,059,136 describes an improved end cap with a handle that can be ergonomically fit into a person's hand. The handle is preferably between 1 and 5 inches long with a T-shape. Although useful, such an end cap must be fabricated from a large portion of metal, thereby considerably increasing the cost of the end cap. In addition, an unwitting person may grasp the end cap without protective gloves and bum themselves during disassembly of a steam sterilized union. Finally, the small mechanical advantage results in limited control of the end cap during the disassembly process which can cause injury or equipment damage.

As a result, there is a considerable need for an improved end cap that can be removed with a simple and convenient tool such as a hygienic clamp. The inventive end cap would also be more cost effective to manufacturer and reduce the likelihood of injury. The end cap could be fabricated of stainless steel, titanium, fluoroplastic, or other suitable material. One skilled in the art would recognize the shape of the protrusion on the inventive end cap may be different depending upon the material of construction.

### SUMMARY OF THE INVENTION

An objective of this invention is to provide a hygienic end cap containing a protrusion that would enable it to be rapidly removed using a hygienic clamp. The end cap has a top and bottom surface with chamfered edges on the top and a gasket groove on the bottom. On the top surface there protrudes a feature long enough to accept the tang portion of the hygienic clamp and transfer the load to the cap to pry off the end cap from the hygienic union. The feature on the top of the end cap could have any shape necessary to accept the hygienic clamp to serve as a fulcrum.

Another objective of the invention is to provide a method to rapidly remove the end cap from the hygienic union. This method utilizes progressively larger hygienic clamps associated with the particular hygienic union to remove the end cap. For example, an 8″ hygienic union uses a larger hygienic clamp compared to a 1″ hygienic union; thus, the mechanical advantage of the clamp acting on the inventive cap increases proportionally with increasing diameter of the hygienic union.

A further objective of this invention is to provide an end cap which is fabricated of a fluoroplastic material to further reduce the cost of the end cap. Fluoroplastics are well known for their low surface tension and ease of removal from sealed surfaces. Thus, the inventive end cap fabricated from a fluoroplastic material affords a lower removal force to disassemble from the hygienic union.

### DESCRIPTION OF THE DRAWINGS

FIG. 1 is a cross-sectional side view of a prior art hygienic union consisting of a ferrule, gasket, and end cap;

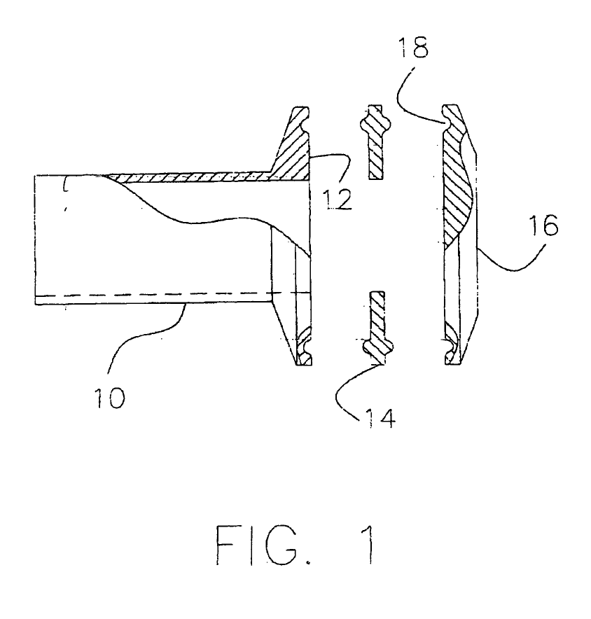

FIG. 2 is a cross-sectional top view of the prior art hygienic union consisting of a ferrule, gasket and clamp;

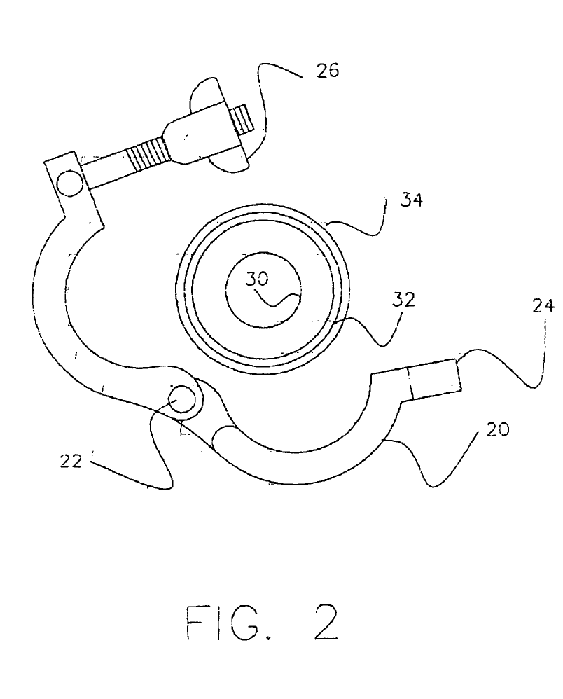

FIG. 3 is a cross-sectional side view of the inventive end cap with the prior art ferrule and gasket;

FIG. 4 is a cross-sectional side view of the prior art ferrule, gasket, and inventive end cap engaged with a hygienic clamp used to remove the inventive cap.

### DETAILED DESCRIPTION OF THE INVENTION

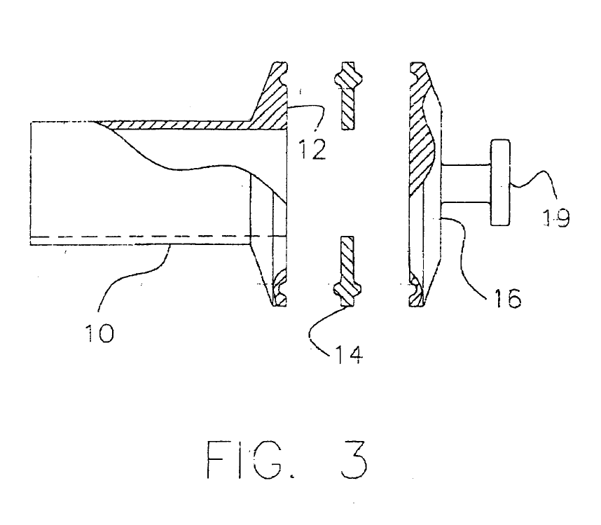

The present invention relates to an improved end cap and to a method for removing the improved end cap with a hygienic clamp. The improved end cap 16 shown in FIG. 3 comprises a protrusion 19 attached to the top of the end cap 16. The end cap 16 has parallel top and bottom sides with the bottom side containing a groove 18 for the sealing gasket 14. The top side of the end cap has chamfered edges to allow the hygienic clamp 20 to properly compress the sealing gasket between the ferrule 10 and the end cap 16. The top side contains the protrusion 19 that engages the tang 24 of the hygienic clamp.

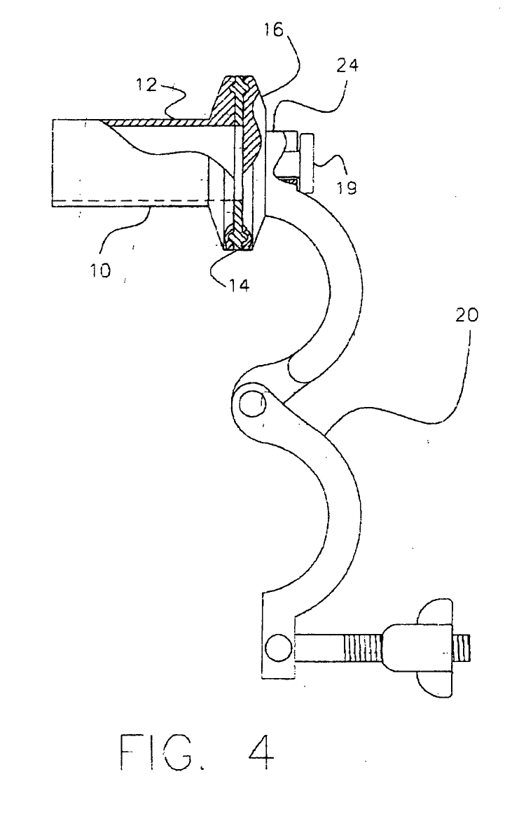

Referring to FIG. 4, to remove the inventive end cap 16, the tang 24 of a clamp 20 is placed under the protrusion 19 and the clamp 20 is pulled away from the ferrule 10, thereby peeling the end cap 16 from the face of the ferrule 10 and rapidly removing it from the sealed hygienic union. The hygienic clamp 20 is operated in the fully opened position to provide maximum mechanical advantage as a fulcrum. The hygienic clamp tool 20 is readily available to the user because it is part of the hygienic union assembly until its removal from the hygienic union during the disassembly process. Thus, no special tools are required to disassemble the inventive end cap 16. Furthermore, hands are not required to touch the potentially hot end cap commonly found in steam sterilized lines or vessels. The end cap 16 is manufactured from stainless steel, titanium, fluoroplastic, or other suitable material.

It will be apparent to one skilled in the art that many other embodiments of this invention are possible, particularly as it relates to the shape of the protrusion necessary to engage the hygienic clamp. The figures contained herein are for explanation only and do not limit the scope of the invention indicated by the following claims.

1. An end cap for a flanged connection comprising:
a bottom portion having a first diameter;
a top portion having a second diameter that is less than said first diameter and beveled inward to said first diameter; and
a protrusion extending outward from said top portion and ending at a rim having a width greater than the width of the protrusion.

2. The end cap of claim 1 wherein the bottom portion has a circular groove for receiving a sealing gasket

3. The end cap of claim 1 wherein the end cap is made of stainless steel.

4. The end cap of claim 1 wherein the end cap is made of titanium.

5. The end cap of claim 1 wherein the end cap is made of fluoroplastic material.

6. The end cap of claim 5 wherein said fluoroplastic material is selected from the group consisting of Teflon®, polyvinylidine flouride, polypropylene, and polyethylene.

7. The end cap of claim 1 wherein the protrusion is cylindrical.

8. The end cap of claim 1 wherein the length of the protrusion is long enough to receive the tang on the end of a hygienic clamp.

9. A method of removing a flanged connection end cap, said method comprising orienting the tang of a clamp onto a protrusion on an end cap, wherein said end cap has a bottom portion having a first diameter and a top portion having a second diameter which is smaller than said first diameter and which is beveled inward to said first diameter and wherein the protrusion extends perpendicularly from the top portion and ends at a rim of greater width than that of the protrusion in order to maintain the position of the tang on said protrusion, locking the clamp in an extended position so that it can be used as a lever, and pushing on the opposite end of the clamp from said tang to peel the end cap from the gasket and ferrule at the flanged connection.

10. The method of claim 9 wherein said bottom portion has a groove for receiving a gasket.

11. The method of claim 9 wherein said end cap is made of stainless steel.

12. The method of claim 9 wherein said end cap is made of titanium.

13. The method of claim 9 wherein said end cap is made of fluoroplastic material.

14. The method of claim 13 wherein said fluoroplastic material is selected from the group consisting of Teflon®, polyvinylidine flouride, polypropylene and polyethylene.

15. The method of claim 9 wherein said protrusion is cylindrical.
